(19) United States
(12) Patent Application Publication
(10) Pub. No.: US 2025/0361424 A1
(43) Pub. Date: Nov. 27, 2025

(54) STICKY INTERLEAF SHEET

(71) Applicant: Samsung Display Co., Ltd., Yongin-Si (KR)

(72) Inventors: Ja Huem KOO, Yongin-si (KR); JIN-WOOK CHO, Yongin-si (KR); SANGKI MIN, Yongin-si (KR)

(21) Appl. No.: 19/042,000

(22) Filed: Jan. 31, 2025

(30) Foreign Application Priority Data
May 22, 2024 (KR) 10-2024-0066556

(51) Int. Cl. C09J 7/10

(52) U.S. Cl. CPC C09J 7/10

(57) ABSTRACT

A disclosed sticky interleaf sheet including an edge, has a cutout portion in which a part of the edge is concave or a hole in the sticky interleaf sheet resides, wherein the cutout portion may include a concavo-convex pattern.

### CROSS-REFERENCE TO RELATED APPLICATION

This application claims priority to and the benefit of Korean Patent Application No. 10-2024-0066556 filed at the Korean Intellectual Property Office on May 22, 2024, the entire contents of which are incorporated herein by reference.

### BACKGROUND OF THE INVENTION

### Field of the Invention

The present disclosure relates to a sticky interleaf sheet.

### Description of the Related Art

Sticky interleaf sheets placed on a seating surface of a tray on which components are loaded, may protect the components by reducing the movement such as sliding of the components. Additionally, regular interleaf sheets placed between layers of the components in multiple layers may further protect the components loaded into the tray. If the shapes of the sticky interleaf sheet and the regular interleaf sheets are similar, a regular interleaf sheet may be mistakenly inserted instead of a sticky interleaf sheet when placing components in the tray, or a sticky interleaf sheet may be mistakenly inserted instead of a regular interleaf sheet.

### SUMMARY OF THE INVENTION

Embodiments disclosed herein may provide a sticky interleaf sheet capable of preventing incorrect insertion of an interleaf sheet in place of the sticky interleaf sheet.

According to an embodiment of the present disclosure, a sticky interleaf sheet including an edge, may have a cutout portion in which a part of the edge is concave. The cutout portion may include a concavo-convex pattern.

The cutout portion may have a border including a first part and a second part respectively connected to the edge and facing each other, and a third part connecting the first part and the second part and having the concavo-convex pattern.

The first part and the second part may be parallel to each other.

The concavo-convex pattern may be symmetrical with respect to a straight line passing through the center of the third part.

The concavo-convex pattern may include a plurality of protrusions protruding toward the edge, and a plurality of grooves open toward the edge.

The plurality of protrusions may include two or more protrusions of different sizes.

The plurality of protrusions may have a sawtooth shape.

A curvature radius of the end of each of the protrusions may be 0.7 mm or more and 1.3 mm or less.

The respective depths of the grooves may be smaller toward the center of the cutout portion.

The respective depths of the grooves may increase toward the center of the cutout portion.

Each of the protrusions may have a rectangular shape, and each of the grooves may have a rectangular shape.

The respective widths of the protrusions and the respective widths of the grooves may be smaller toward the center of the cutout portion.

The respective depths of the grooves may be smaller toward the center of the cutout portion.

The respective widths of the protrusions and the respective widths of the grooves may increase toward the center of the cutout portion.

The respective depths of the grooves may increase toward the center of the cutout portion.

The ends of the plurality of protrusions may be on the same straight line.

The width of the cutout portion may be 177 mm or more and 183 mm or less.

A sticky interleaf sheet, according to another embodiment, including an edge, includes a cutout hole spaced apart from the edge and penetrating the edge. The cutout hole may include a concavo-convex pattern.

The cutout hole may have a border including a fourth part spaced apart from the edge, a fifth part and a sixth part respectively connected to the fourth part and facing each other, and a seventh part connecting the fifth part and the sixth part and having the concavo-convex pattern.

Embodiments disclosed herein may prevent incorrect insertion by forming a cutout portion or a cutout hole including a concavo-convex pattern on at least one side of the sticky interleaf sheet.

### BRIEF DESCRIPTION OF THE DRAWINGS

FIG. 1 is an exploded view of a tray with a sticky interleaf sheet according to an embodiment.

FIG. 2 is a cross-sectional view taken along line A-A′ of FIG. 1.

FIG. 3 is a plan view of a sticky interleaf sheet according to an embodiment.

FIG. 4 illustrates a region B in FIG. 3.

FIG. 5 is an enlarged view of a portion of FIG. 4.

FIG. 6 is a plan view of a sticky interleaf sheet according to another embodiment.

FIG. 7 illustrates a concavo-convex pattern of a sticky interleaf sheet according to another embodiment.

FIG. 8 illustrates a concavo-convex pattern of a sticky interleaf sheet according to another embodiment.

FIG. 9 is a graph illustrating changes in shading according to the position of region B in FIG. 3.

FIG. 10 is a graph illustrating changes in shading according to the position of a region C in FIG. 3.

FIG. 11 is a plan view of a sticky interleaf sheet according to another embodiment.

FIG. 12 is a plan view of a cutout hole in the sticky interleaf sheet of FIG. 11.

FIG. 13 is a plan view of a sticky interleaf sheet according to another embodiment.

FIG. 14 illustrates a concavo-convex pattern of a sticky interleaf sheet according to another embodiment.

FIG. 15 illustrates a concavo-convex pattern of a sticky interleaf sheet according to another embodiment.

### DETAILED DESCRIPTION OF THE EMBODIMENTS

The present disclosure will be described in detail hereinafter with reference to the accompanying drawings, in which example embodiments of the present disclosure are shown. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

The size and thickness of each constituent element in the drawings may be shown for better understanding and ease of description, and the following embodiments are not limited thereto. In the drawings, the thickness of layers, films, panels, regions, etc., may be exaggerated for clarity. In the drawings, the thickness of some layers and regions may be exaggerated for ease of description.

An element such as a layer, film, region, or substrate referred to herein as being “on” another element may be directly on the other element or intervening elements may also be present. In contrast, when an element is referred to as being “directly on” another element, no intervening elements are present. Further, an element referred to herein as being “on” or “above” a reference element may be positioned above or below the reference element and is not necessarily positioned “on” or “above” in a direction opposite to gravity.

In addition, unless explicitly described to the contrary, the word “comprise,” and variations such as “comprises” or “comprising,” imply the inclusion of stated elements but not the exclusion of any other elements.

In addition, the phrase “plan view” means a view from a position above the object (e.g., from the top), and the phrase “on a cross-section” means a view of a cross-section of the object which is vertically cut from the side.

In this specification, x, y, and z each represent the directions of coordinate axes that that are perpendicular to each other, and the plane containing the x and y axes is called the xy plane, the plane containing the y and z axes is called the yz plane, and the plane containing the z and x axes is called the zx plane.

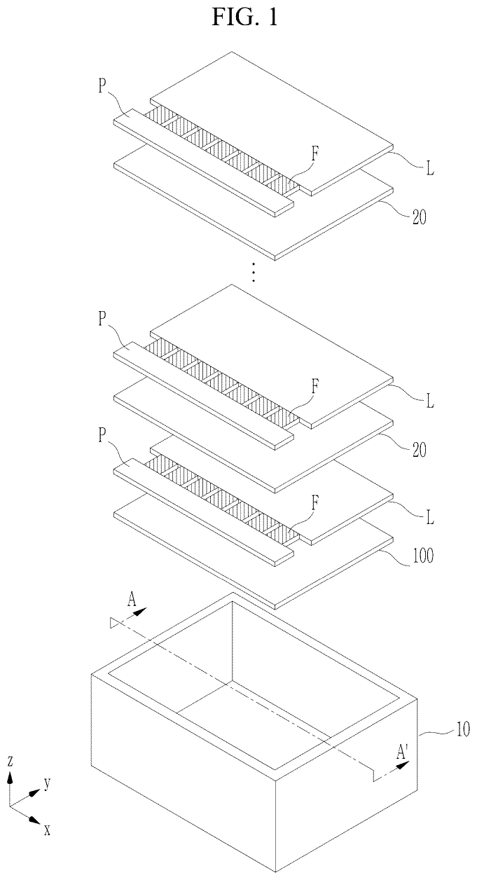

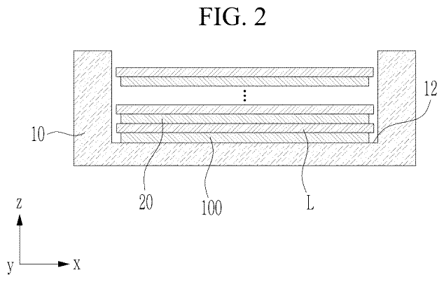

FIG. 1 is an exploded view of a tray with a sticky interleaf sheet according to an embodiment, and FIG. 2 is a cross-sectional view taken along line A-A′ of FIG. 1.

Referring to FIGS. 1 and 2, a sticky interleaf sheet 100 is used when loading a component L on a tray 10. That is, the sticky interleaf sheet 100 is on a seating surface 12 of the tray 10, and the component L is on the sticky interleaf sheet 100. The sticky interleaf sheet 100 has a sheet shape, and one or both major surfaces of the sticky interleaf sheet 100 may be adhesive. The sticky interleaf sheet 100 may be simultaneously fixed to the component L and the seating surface 12 of the tray 10. Accordingly, the sticky interleaf sheet 100 may prevent the component L from sliding on the seating surface 12 of the tray 10.

A plurality of components L may be loaded or stacked in the tray 10. In which case, a regular interleaf sheet 20 may be placed between a pair of components L that are adjacent in the tray 10. The regular interleaf sheet may be made of, for example, synthetic resin, but the present disclosure is not limited thereto.

As described above, first, the sticky interleaf sheet 100 may be placed on the seating surface 12 of the tray 10, and then one of the components L may be loaded onto the sticky interleaf sheet 100. Subsequently, one of the regular interleaf sheets 20 may be placed on the component L in the tray 10, and an additional component L may be loaded onto the regular interleaf sheet 20.

Each component L may be, for example, a display panel. The display panel may include a plurality of pixels arranged in a matrix format on a glass substrate. The display panel may be connected to a printed circuit board P by one or more flexible circuit boards F to drive the plurality of pixels. However, the present disclosure is not limited thereto.

An embodiment of the sticky interleaf sheet 100 is described in more detail below.

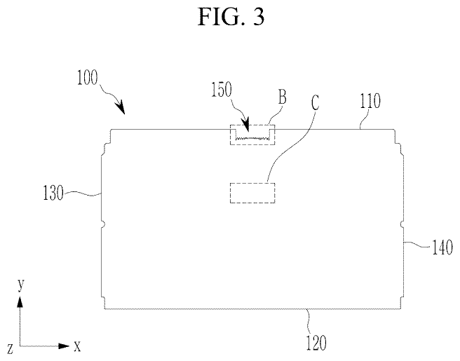

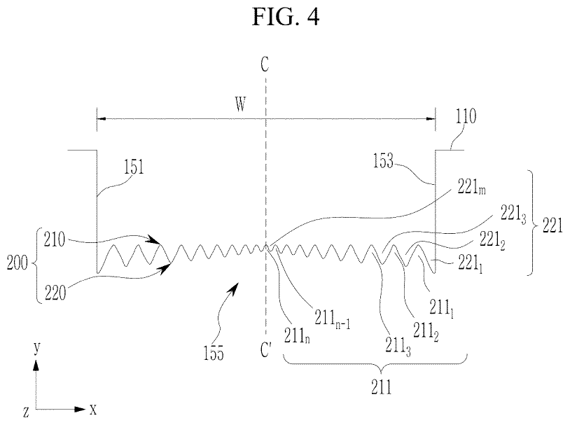

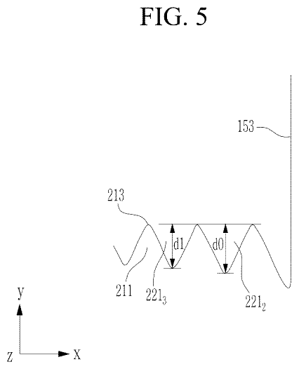

FIG. 3 is a plan view illustrating a sticky interleaf sheet according to an embodiment, FIG. 4 illustrates region B identified in FIG. 3, and FIG. 5 is an enlarged view of a portion of FIG. 4.

Referring to FIGS. 3 to 5, the sticky interleaf sheet 100 has a sheet shape and may be generally rectangular when viewed along the z-axis direction. The sticky interleaf sheet 100 may have the same shape as the regular interleaf sheet 20, except that the sticky interleaf sheet 100 includes a cutout portion 150 as described further below. That is, the sticky interleaf sheet 100 may include a first edge 110, a second edge 120, a third edge 130, and a fourth edge 140, which may be the same as corresponding edges of the regular interleaf sheet 20. However, the present disclosure is not limited thereto, and the planar shape of the sticky interleaf sheet 100 when viewed along the z-axis direction may vary depending on the shape of the storage space (e.g., seating surface) of the tray 10 or the shape of the component L to be loaded into the tray 10.

The sticky interleaf sheet 100 includes at least one cutout portion 150. The cutout portion 150 may be at least a portion of one of the first to fourth edges 110, 120, 130, and 140 of the sticky interleaf sheet 100 that may be cut or otherwise formed to be concave relative to the edge 110, 120, 130, or 140 when uncut. In the embodiment of FIG. 3, the cutout portion 150 is on the first edge 110 of the sticky interleaf sheet 100 and is concave relative to the first edge 140. In this case, the cutout portion 150 may be formed by punching the sticky interleaf sheet 100 at a location along the first edge 110. However, the method of forming the cutout portion 150 is not limited to the method described above.

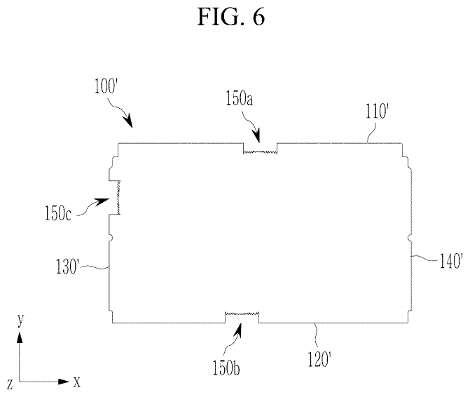

In other embodiments, for example, referring to FIG. 6, cutout portions 150a, 150b, and 150c may be formed on a first edge 110′, a second edge 120′, and a third edge 130′ of a sticky interleaf sheet 100′, respectively. However, the position and number of the cutout portions 150a, 150b, and 150c are not limited to these specific examples.

Referring to FIG. 4, the cutout portion 150 may have an edge or border including a first part 151, a second part 153, and a third part 155.

The first part 151 and the second part 153 are each connected to or extend from the first edge 110 of the sticky interleaf sheet 100 and face each other in the x-axis direction. For example, the first part 151 and the second part 153 may include straight-line parts parallel to the y-axis direction and may be parallel to each other. However, the first part 151 and the second part 153 do not necessarily include straight-line parts, and may include parts with different shapes, such as curved parts or bent parts.

The third part 155 connects the first part 151 and the second part 153 and includes a concavo-convex pattern 200. The concavo-convex pattern 200 may have a shape in which convex portions 210 and recess portions 220 are alternately arranged. Each convex portion 210 may be a portion of the sticky interleaf sheet 100 that protrudes in the y-axis direction, and each recess portion 220 may be a portion of the cutout portion 150 that is between two adjacent convex portions 210.

The convex portion 210 may include a plurality of protrusions 211₁, 211₂, 211₃, . . . , 211ₙ (n being a natural number), and the recess portion 220 may include a plurality of grooves 221₁, 221₂, 221₃, . . . , 221ₘ (m being a natural number). Hereinafter, any one protrusion 211₁, 211₂, 211₃, . . . , or 211ₙ may be generically referred to as “protrusion 211,” and any one groove 221₁, 221₂, 221₃, . . . , or 221ₘ may be generically referred to as “groove 221.”

The plurality of protrusions 211₁, 211₂, 211₃, . . . , 211ₙ includes two or more protrusions of different sizes. For example, the protrusions 211₁, 211₂, 211₃, . . . , 211ₙ may each have different sizes.

The concavo-convex pattern 200 may be symmetrical about a straight line (C-C′) passing through the center of the third part 155 in the x-axis direction. That is, the shape of the concavo-convex pattern 200 on one side of the straight line (C-C′) may be symmetrical to the shape of the concavo-convex pattern 200 on the other side of the straight line (C-C′). Here, the straight line (C-C′) may be parallel to the first part 151 or the second part 153 or may extend perpendicular to the first edge 110. For example, referring to FIG. 4, a plurality of protrusions with a shape symmetrical to a plurality of protrusions 211₁, 211₂, 211₃, . . . , 211ₙ₋₁ on the right side of the straight line (C-C′) are on the left side of the straight line (C-C′). In addition, a plurality of grooves with a shape symmetrical to a plurality of grooves 211₁, 211₂, 211₃, . . . , 211ₘ on the right side of the straight line (C-C′) are on the left side of the straight line (C-C′). In some embodiments, depending on the shape of the concavo-convex pattern 200, one of the protrusions 211 or the grooves 221 may be at the center of the third part 155 in the x-axis direction.

Each protrusion 211 may generally have a sawtooth or triangular shape. However, the vertex of each protrusion 211 may not form a sharp angle. For example, a vertex 213 of each protrusion 211 may be rounded with a curvature radius of 0.7 mm or more and 1.3 mm or less. If the curvature radius is less than 0.7 mm, the sticky interleaf sheet 100 may be easily damaged during a punching process that forms the cutout portion 150, and a curvature radius exceeding 1.3 mm may be disadvantageous in terms of implementing a sawtooth or triangular shape of a desirable size. However, this numerical range is merely illustrative, and the present disclosure is not limited thereto.

The vertices 213 of the protrusions 211 may all be on the same straight line (e.g., a straight line parallel to the x-axis direction), but the present disclosure is not limited thereto.

The plurality of grooves 221₁, 221₂, 221₃, . . . , 221ₘ includes two or more grooves of different sizes. For example, the plurality of grooves 221₁, 221₂, 221₃, . . . , 221ₘ may each have different sizes. Here, the size of a groove may refer to the size of the width of the groove, the depth of the groove, or both.

The depths of the grooves 221₁, 221₂, 221₃, . . . , 211ₘ may be smaller toward the center in the x-axis direction of the cutout portion 150. For example, referring to FIGS. 4 and 5, a depth d1 of the groove 221₃ closer to the straight line (C-C′) passing through the center in the x-axis direction of the third part 155 is smaller than a depth do of the groove 221₂ farther away from the straight line (C-C′).

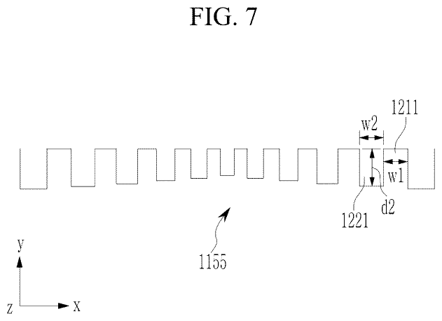

The shapes of the protrusions and grooves are not limited to those described above and may have different shapes in other embodiments. For example, referring to FIG. 7, each protrusion 1211 has a generally rectangular shape and each groove 1221 also has a generally rectangular shape. Widths w1 of the protrusions 1211 and widths w2 of the grooves 1221 may be smaller toward the center in the x-axis direction of a third part 1155. Additionally, depths d2 of the grooves 1221 may be smaller toward the center in the x-axis direction of the third part 1155.

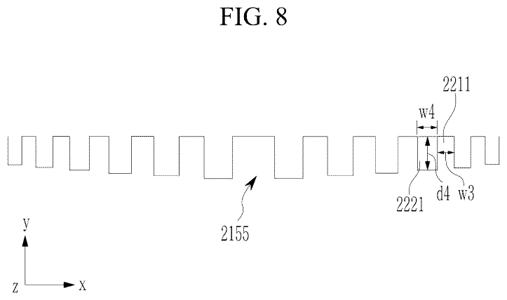

As another example, referring to FIG. 8, each protrusion 2211 has a generally rectangular shape, and each groove 2221 also has a generally rectangular shape. Widths w3 of the protrusions 2211 and widths w4 of the groove 2221 may be smaller toward the center in the x-axis direction of a third part 2155. Additionally, depths d4 of the grooves 2221 increases toward the center in the x-axis direction of the third part 2155.

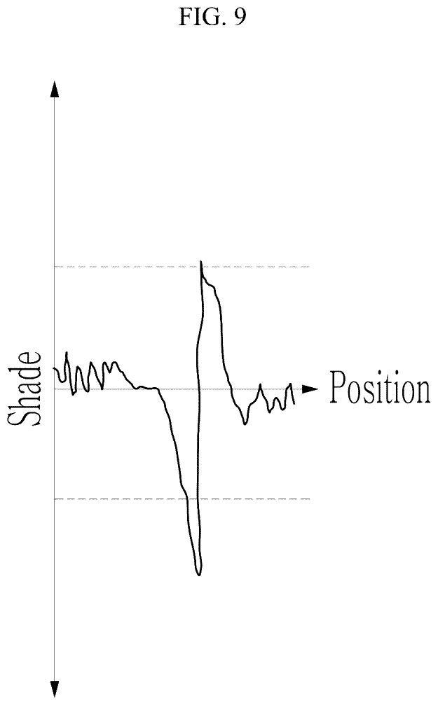

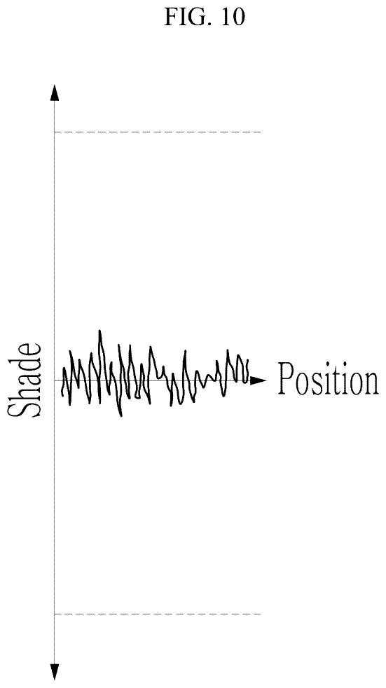

A machine vision process may use the cutout portion described above to identify a sticky interleaf sheet and particularly to distinguish a sticky interleaf sheet from a regular interleaf sheet. FIG. 9 is a graph illustrating changes in shading according to the position of region B in FIG. 3, and FIG. 10 is a graph illustrating changes in shading according to the position of region C in FIG. 3.

Referring to FIG. 9, a rapid change in shading in a specific section may be seen from an image captured in region B with a vision camera. Since region B includes the cutout portion 150 having the concavo-convex pattern shaped as described above, shading in images rapidly changes as the position of the cutout portion 150 changes relative to the camera. The shading changes in the images may be contrast differences for camera identification.

On the other hand, referring to FIG. 10, the change in shading in region C with changes in the position of the sticky interleaf sheet is relatively smaller than the changes in shading in region B. That is, unlike region B, region C does not include a cutout portion and therefore does not show a rapid change in shading.

As such, since the sticky interleaf sheet according to the embodiment includes a cutout portion, the region where the cutout portion is formed shows a rapid change in shading in an image captured with a vision camera. In contrast, regular interleaf sheets do not include cutouts, so the regular interleaf sheets do not show rapid changes in shading. This difference allows machine vision to distinguish between sticky interleaf sheets according to the embodiment and regular interleaf sheets, thereby preventing incorrect insertion of interleaf sheets.

In one specific example, the width (W, see FIG. 4) of the cutout portion 150 may be 177 mm or more and 183 mm or less. However, this numerical range is only an example and may be altered according to the performance of the vision camera, and the present disclosure is not limited thereto. Here, the width W of the cutout portion 150 may be a distance between the point where the first part 151 and the first edge 110 meet and the point where the second part 153 and the first edge 110 meet, or the width W of the cutout portion 150 may be the average distance between the first part 151 and the second part 153 of the cutout portion 150.

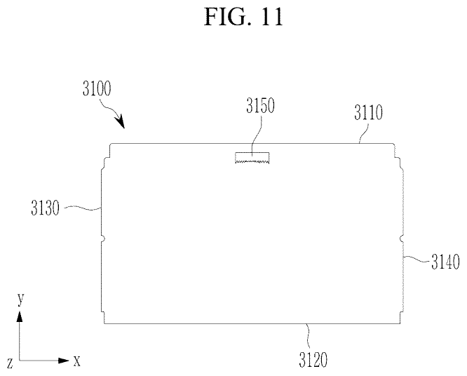

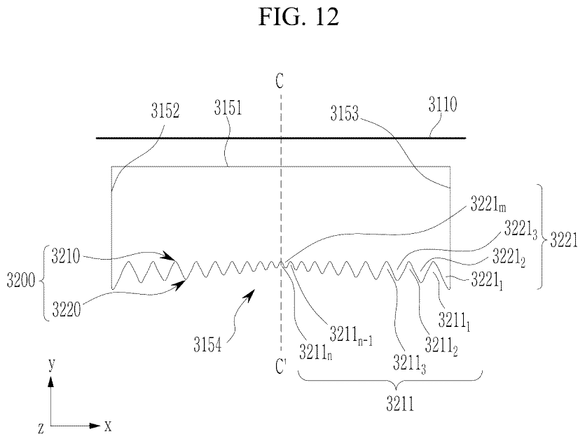

FIG. 11 is a plan view illustrating a sticky interleaf sheet according to another embodiment, and FIG. 12 is a plan view of a cutout hole in the sticky interleaf sheet of FIG. 11. Referring to FIGS. 11 and 12, a sticky interleaf sheet 3100 has a sheet-like shape and is generally rectangular when viewed in the z-axis direction.

The sticky interleaf sheet 3100 includes a cutout hole 3150. The cutout hole 3150 may be adjacent to at least one of first to fourth edges 3110, 3120, 3130, and 3140 of the sticky interleaf sheet 3100. In the illustrated example, the cutout hole 3150 may be formed adjacent to the first edge 3110 of the sticky interleaf sheet 3100. In this example, the cutout hole 3150 may be formed by perforating the sticky interleaf sheet 3100 at a location spaced apart from the first edge 3110. However, the method of forming the cutout hole 3150 is not limited to the method described above.

The cutout hole 3150 may have a border including a first part 3151, a second part 3152, a third part 3153, and a fourth part 3154.

The first part 3151 may be spaced apart from the first edge 3110 of the sticky interleaf sheet 3100 and may include a straight-line part parallel to the x-axis direction. For example, the first part 3151 may be parallel to the first edge 3110. Accordingly, the cutout hole 3150 may have a closed structure rather than being open toward any edge 3110, 3120, 3130, or 3140 of the sticky interleaf sheet 3100.

The second part 3152 and the third part 3153 are each connected to the first part 3151 and face each other in the x-axis direction. For example, the second part 3152 and the third part 3153 may include straight-line parts parallel to the y-axis direction and may be parallel to each other. However, the second part 3152 and the third part 3153 do not necessarily include straight-line parts and may include curved parts or bent parts.

The fourth part 3154 faces the first part 3151 in the y-axis direction and connects the second part 3152 and the third part 3153. Additionally, the fourth part 3154 includes a concavo-convex pattern 3200. The concavo-convex pattern 3200 may have a shape that results from convex portions 3210 and recess portions 3220 being alternately arranged along the fourth part 3154.

The convex portions 3210 includes a plurality of protrusions 3211₁, 3211₂, 3211₃, . . . , 3211ₙ (n being a natural number), and the recess portion 3220 includes a plurality of grooves 3221₁, 3221₂, 3221₃, . . . , 3221ₘ (m being a natural number). Any one of the protrusions 3211₁, 3211₂, 3211₃, . . . , 3211ₙ may be generically referred to herein as the protrusion 3211, and any one of the grooves 3221₁, 3221₂, 3221₃, . . . , 3221ₘ may be generically referred to herein as the groove 3221.

Except for the differences described above, the remaining components of the embodiment shown in FIGS. 11 and 12 may be the same as or correspond to the components of the embodiments shown in FIGS. 1 to 5, so repeated descriptions thereof will be omitted.

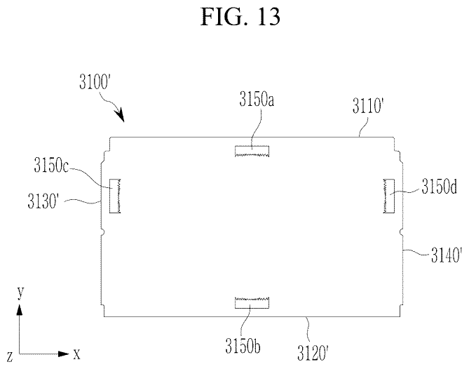

FIG. 13 is a plan view illustrating a sticky interleaf sheet according to another embodiment. Referring to FIG. 13, a sticky interleaf sheet 3100′ includes first to fourth cutout holes 3150a, 3150b, 3150c, and 3150d. In the illustrated example, the first cutout hole 3150a is formed adjacent to a first edge 3110′ of the sticky interleaf sheet 3100′. The second cutout hole 3150b is formed adjacent to a second edge 3120′. The third cutout hole 3150c is formed adjacent to a third edge 3130′, and the fourth cutout hole 3150d is formed adjacent to a fourth edge 3140′. However, the positions and number of the cutout portions 3150a, 3150b, 3150c, and 3150d are not limited thereto.

Except for the differences described above, the remaining components of the embodiment shown in FIG. 13 may be the same as or correspond to the components of the embodiment shown in FIGS. 11 and 12, so repeated descriptions thereof will be omitted.

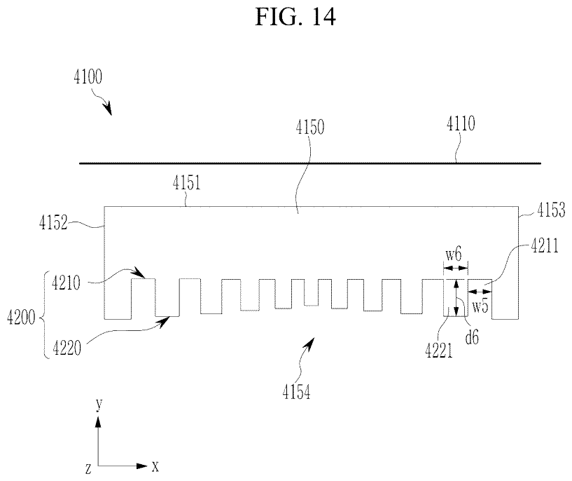

FIG. 14 illustrates a concavo-convex pattern of a sticky interleaf sheet according to another embodiment. Referring to FIG. 14, a sticky interleaf sheet 4100 includes a cutout hole 4150, which is adjacent to a first edge 4110 of the sticky interleaf sheet 4100. The cutout hole 4150 may have a border including a first part 4151, a second part 4152, a third part 4153, and a fourth part 4154.

The fourth part 4154 includes a concavo-convex pattern 4200. The concavo-convex pattern 4200 includes a convex portion 4210 and a recess portion 4220. The convex portion 4210 includes a plurality of protrusions 4211, and the recess portion 4220 includes a plurality of grooves 4221. The protrusions 4211 have a generally rectangular shape, and the grooves 4221 also have a generally rectangular shape. Widths w5 of the protrusions 4211 and widths w6 of the grooves 4221 may be smaller toward the center in the x-axis direction of the fourth part 4154. Additionally, depths d6 of the grooves 4221 may be smaller toward the center in the x-axis direction of the fourth part 4154.

Except for the differences described above, the remaining components of the embodiment shown in FIG. 14 may be the same as or correspond to the components of the embodiment shown in FIGS. 11 and 12, so repeated descriptions thereof will be omitted.

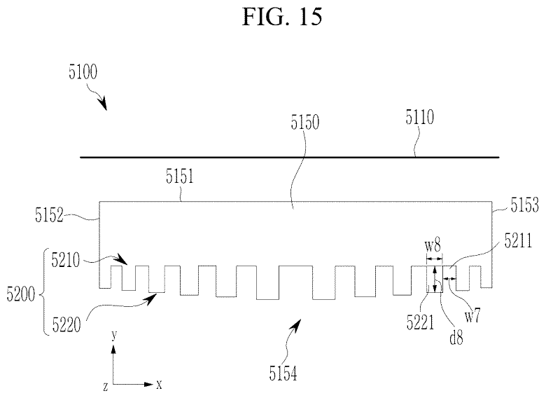

FIG. 15 illustrates a concavo-convex pattern of a sticky interleaf sheet according to another embodiment. Referring to FIG. 15, a sticky interleaf sheet 5100 includes a cutout hole 5150. The cutout hole 5150 may be formed adjacent to a first edge 5110 of the sticky interleaf sheet 5100. The cutout hole 5150 may have a border including a first part 5151, a second part 5152, a third part 5153, and a fourth part 5154.

The fourth part 5154 includes a concavo-convex pattern 5200. The concavo-convex pattern 5200 includes a convex portion 5210 and a recess portion 5220. The convex portion 5210 includes a plurality of protrusions 5211 and the concave portion 5220 includes a plurality of grooves 5221. The protrusions 5211 have a generally rectangular shape, and the grooves 5221 also have a generally rectangular shape. Widths w7 of the protrusions 5211 and widths w8 of the grooves 5221 increase toward the center in the x-axis direction of the fourth part 5154. Additionally, a depth d8 of the grooves 5221 increases toward the center in the x-axis direction of the fourth part 5154.

Except for the differences described above, the remaining components of the embodiment shown in FIG. 15 may be the same as or correspond to the components of the embodiment shown in FIGS. 11 and 12, so repeated descriptions thereof will be omitted.

While the embodiments of the present disclosure have been described in detail, the disclosure is not limited to the disclosed embodiments, but on the contrary, is intended to cover various modifications and equivalent arrangements included within the spirit and scope of the appended claims.

What is claimed is:

1. A sticky interleaf sheet including an edge, comprising:
a cutout portion in which a part of the edge is concave,
wherein the cutout portion comprises a concavo-convex pattern.

2. The sticky interleaf sheet of claim 1, wherein
the cutout portion has a border including a first part and a second part respectively extending from the edge and facing each other, and a third part connecting the first part and the second part and having the concavo-convex pattern.

3. The sticky interleaf sheet of claim 2, wherein the first part and the second part are parallel to each other.

4. The sticky interleaf sheet of claim 2, wherein the concavo-convex pattern is symmetrical with respect to a straight line passing through a center of the third part.

5. The sticky interleaf sheet of claim 1, wherein the concavo-convex pattern comprises:
a plurality of protrusions protruding toward the edge; and
a plurality of grooves opening toward the edge.

6. The sticky interleaf sheet of claim 5, wherein the plurality of protrusions comprises two or more protrusions of different sizes.

7. The sticky interleaf sheet of claim 5, wherein each of the protrusions has a triangular shape.

8. The sticky interleaf sheet of claim 7, wherein each of the protrusions has a vertex with a curvature radius that is 0.7 mm or more and 1.3 mm or less.

9. The sticky interleaf sheet of claim 5, wherein depths of the grooves are smaller toward a center of the third part.

10. The sticky interleaf sheet of claim 5, wherein depths of the grooves increase toward a center of the third part.

11. The sticky interleaf sheet of claim 5, wherein
each of the protrusions has a rectangular shape,
and each of the grooves has a rectangular shape.

12. The sticky interleaf sheet of claim 11, wherein widths of the protrusions and widths of the grooves are smaller toward a center of the third part.

13. The sticky interleaf sheet of claim 12, wherein depths of the grooves are smaller toward the center of the third part.

14. The sticky interleaf sheet of claim 5, wherein widths of the protrusions and widths of the grooves increase toward a center of the third part.

15. The sticky interleaf sheet of claim 14, wherein depths of the grooves increase toward the center of the third part.

16. The sticky interleaf sheet of claim 5, wherein ends of the plurality of protrusions are on the same straight line.

17. The sticky interleaf sheet of claim 1, wherein a width of the cutout portion is 177 mm or more and 183 mm or less.

18. A sticky interleaf sheet including an edge, comprising:
a cutout hole spaced apart from the edge and penetrating the edge,
wherein the cutout hole comprises a concavo-convex pattern.

19. The sticky interleaf sheet of claim 18, wherein the cutout hole has a border comprising:
a fourth part spaced apart from the edge;
a fifth part and a sixth part respectively connected to the fourth part and facing each other; and
a seventh part connecting the fifth part and the sixth part and having the concavo-convex pattern.
